(19) United States
(12) Patent Application Publication
(10) Pub. No.: US 2006/0139784 A1
(43) Pub. Date: Jun. 29, 2006

(54) Uniformity correction system having light leak compensation

(75) Inventor: Douglas M. Casault, Milford, CT (US)

Correspondence Address: STERNE, KESSLER, GOLDSTEIN & FOX P.L.L.C., 1100 NEW YORK AVE., N.W., WASHINGTON, DC, 20005, US

(73) Assignee: ASML Holding N.V., Veldhoven (NL)

(21) Appl. No.: 11/022,829

(22) Filed: Dec. 28, 2004

(51) Int. Cl. G02B 5/22

(52) U.S. Cl. 359/885

(57) ABSTRACT

A system and method for uniformity correction having light leak compensation is provided. The system includes multiple correction elements. The correction elements can be moved within an illumination slot. Adjacent correction elements are separated by a gap. Each correction element includes a compensation portion and a normal attenuation portion. The compensation portion has a first attenuation and normal attenuation portion has a second attenuation. The width of the compensation portion is equivalent to the width of the gap between adjacent fingers. The compensation portion can be band on a surface of the correction element. The band extends from a first point on a longitudinal edge of the correction element to a second point on a longitudinal edge of the correction element.

### FIELD OF THE INVENTION

The present invention is generally related to uniformity correction in lithography systems.

### BACKGROUND OF THE INVENTION

Conventional lithography systems include, among other things, an illumination system to produce a uniform intensity distribution of a received laser beam. It is desirable that the resulting illumination be as uniform as possible and that any uniformity errors be kept as small as possible. Illumination uniformity influences the ability of an illumination system to produce uniform line widths across an entire exposure field. Illumination uniformity errors can significantly impact the quality of devices produced by the lithography system.

Techniques for correcting uniformity include correction systems that have multiple correction elements such as plates inserted from opposites of an illumination slot. These correction elements have non-zero attenuation (e.g., 90%). However, due to various constraints, a gap exists between adjacent correction elements. The gaps between adjacent correction elements generate unwanted optical effects such as gap ripples and shadows. Because each gap has a 0% attenuation (or 100% transmission) and the correction elements have non-zero attenuation, light through the gaps generate streaks or bands of greater intensity on the substrate. The bands of greater intensity impact the width of lines in the exposure field. Furthermore, each correction element has a finite thickness. Thus, each correction elements has a plurality of edges. If light is coming in on an angle (i.e., larger sigma), part of the light reflects off the edge, casting a shadow on the substrate.

Therefore, what is needed is a uniformity correction system that compensates for optical effects created by gaps between adjacent correction elements, that provides increased uniformity across the slot, and that improves critical dimensions.

### SUMMARY OF THE INVENTION

The present invention is directed to a system and method for uniformity correction having light leak compensation. In accordance with an aspect of the present invention, the system for uniformity correction includes a plurality of correction elements. In an embodiment, the correction elements are moveable within an illumination slot. Adjacent correction elements are separated by a gap. Each correction element includes a compensation portion and a normal attenuation portion. In an embodiment of the invention, compensation portion has a first attenuation and normal attenuation portion has a second attenuation. The width of the compensation portion is equivalent to the width of the gap between adjacent fingers.

In an embodiment, the compensation portion is a band on the first surface of the correction element. The band extends from a first point on the first longitudinal edge of the correction element to a second point on the first longitudinal edge of the correction element. In an embodiment, the first point is coincident with the first latitudinal edge of the correction element. In an alternate embodiment, the band extends from a first point on the second longitudinal edge of the correction element to a second point on the second longitudinal edge of the correction element. In a further embodiment, the compensation portion is a band on the second surface of the correction element. The band extends along the first longitudinal edge or along the second longitudinal edge.

The compensation band is formed of any material having an attenuation. In an embodiment, the compensation band is a coating applied to a surface of the correction element. In an alternate embodiment, the compensation band is within the correction element.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary lithography system having uniformity correction, according to an embodiment of the present invention.

FIGS. 2A-B depict high level block diagrams of exemplary uniformity correction systems, according to embodiments of the present invention.

FIG. 3 depicts optical effects created by the gaps between adjacent correction elements.

FIG. 4 further illustrates the cause of gap ripple.

FIGS. 5A and B depict an exemplary correction element, having compensation for optical effects caused by edges and gaps between correction elements, according to an embodiment of the present invention.

FIG. 6A depicts a portion of an exemplary uniformity correction system having light leak compensation, according to an embodiment of the present invention.

FIG. 6B depicts the cross-slot averaged attenuation with the uniformity correction system having light leak compensation.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

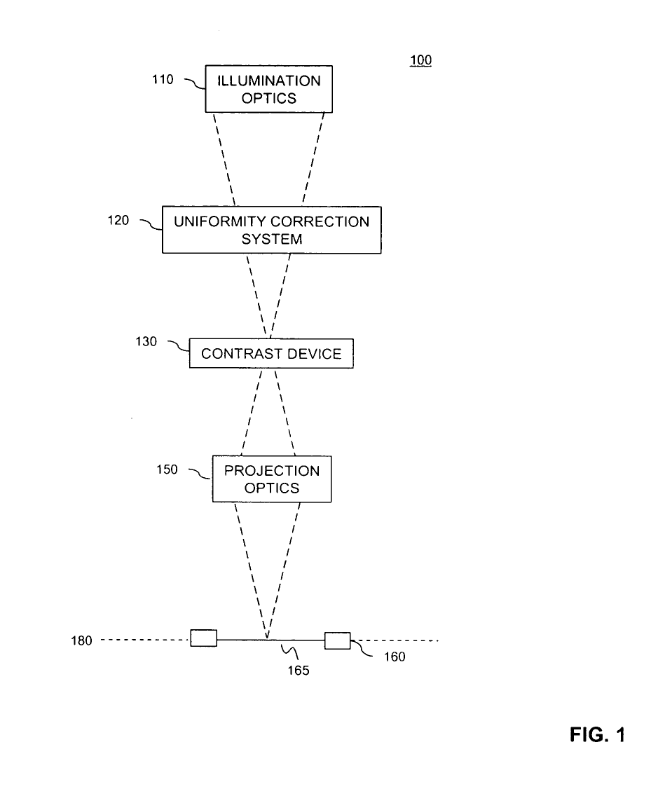

FIG. 1 is an illustration of an exemplary lithography system 100, according to an embodiment of the invention. In an embodiment, lithography system 100 is a system using a reticle or mask. In an alternate embodiment, system 100 is a maskless lithography system.

Lithography system 100 includes an illumination system 110, a uniformity correction system 120, a contrast device 130, projection optics 150, and a substrate stage 160.

Illumination system 110 illuminates contrast device 130. Illumination system 110 may use any type of illumination (e.g., quadrapole, annular, etc.) as required by the lithography system. In addition, illumination system 110 may support the modification of various illumination properties such as partial coherence or fill geometry. The details of illumination systems are well known to those skilled in the art and thus are not explained further herein.

Contrast device 130 is used to image a pattern onto a portion of a substrate 165 (e.g., wafer or glass plate) held by substrate stage 160. In a first embodiment, contrast device 135 is a static mask such as a reticle and substrate 165 is a wafer. In a second maskless embodiment, contrast device 135 is a programmable array. The programmable array may include a spatial light modulator (SLM) or some other suitable micro-mirror array. Alternatively, the SLM can comprise a reflective or transmissive liquid crystal display (LCD) or a grading light value (GLV). In the second embodiment, substrate 165 may be a piece of glass, flat panel display, or similar.

Projection optics 150 is configured to project an image of the pattern (defined by the contrast device) on the substrate. The details of projection optics 150 are dependent upon the type of lithography system used. Specific functional details of projection optics are well known to those skilled in the art and therefore are not explained further herein.

Substrate stage 160 is located at the image plane 180. Substrate stage 160 supports a substrate 165. In an embodiment, the substrate is a resist coated wafer. In an alternate embodiment, the substrate is a piece of glass, flat pane display or similar.

Uniformity correction system 120 is a device that controls illumination levels within specific sections of illumination fields associated with system 100. The uniformity correction system 120 is positioned between the illumination optics 110 and the contrast device stage 130 at the correction plane. In an embodiment, the correction plane is located proximate to the contrast device stage (e.g., reticle stage). In alternative embodiments, the correction plane can be located at any position between illumination optics 110 and contrast device stage 130.

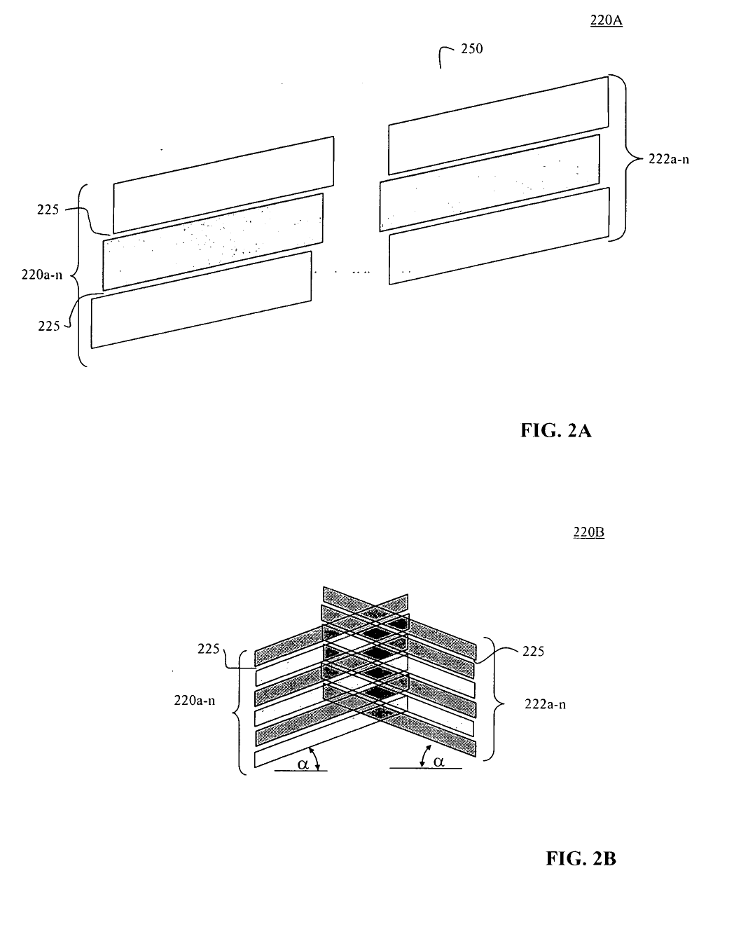

FIGS. 2A and B depict a high level block diagrams of exemplary uniformity correction systems 220. As depicted in FIGS. 2A and 2D, a uniformity correction system includes multiple correction elements 220a-n and optional multiple correction elements 222a-n. Multiple correction elements 220a-n and 222a-n are inserted into the illumination slot in a defined configuration. Multiple correction elements 220, 222 can be any mechanism that effects uniformity. In an embodiment, multiple correction elements 220a-n and 222a-n are plates (also referred to as fingers) constructed of a transmissive material. For example, in an embodiment, each finger has a 10% attenuation. As would be appreciated by persons of skill in the art, other attenuations could be used for the correction elements. In addition, a correction element could have varying attenuations.

FIG. 2A is a top down view of correction system 220A. In correction system 220A, the multiple correction elements 220a-n and 222a-n have a tilted configuration. In this configuration, multiple correction elements 220a-n are inserted from a first side (e.g., the left side) of the illumination slot at an angle α with respect to the scan direction (or Y-axis). Multiple correction elements 222a-n are inserted from the opposite side (e.g., right side) of the illumination slot at an angle −α with respect to the scan direction (or Y-axis). In an embodiment, the maximum insertion of correction elements 220a-n and 222a-n is to a neutral point. That is, each correction element can be inserted any amount up to a point at which the tip of a correction element 220 is proximate to the tip of a correction element 222. In this embodiment, correction elements 220a-n do not overlap correction elements 222a-n.

As can be seen in FIG. 2A, in this configuration, each correction element 220a-n is opposed to its corresponding correction element 222a-n (e.g., correction element 220a is opposed to correction element 222a, correction element 220b is opposed to correction element 222b, etc.). Thus, each correction element 220a-n and its corresponding correction element 222a-n can be considered as being in the same correction slot. Although FIG. 2A only depicts four correction elements per side, any number of fingers per side could be used in the present invention.

FIG. 2B is a top down view of correction system 220B. In correction system 220B, the multiple correction elements 220a-n and 222a-n have a chevron configuration. In this configuration, multiple correction elements 220a-n are inserted from a first side (e.g., the left side) of the illumination slot at an angle α with respect to the scan direction (or Y-axis). Multiple correction elements 222a-n are inserted from the opposite side (e.g., right side) of the illumination slot at the same angle, a, with respect to the scan direction (or Y-axis). In this configuration, correction elements 220 and 222 can be inserted to a depth such that correction elements 220 overlap correction elements 222. In this embodiment, each correction element can be inserted any amount up to a maximum insertion point.

As can be seen in FIGS. 2A and B, adjacent correction elements (e.g. 220a-n, 222a-n) are separated by a gap 225a-n. As would be appreciated by a person of skill in the art, adjacent fingers can be separated by any size gap, as required by the constraints of the compensation system. In an embodiment, each gap 225a-n are equal in size.

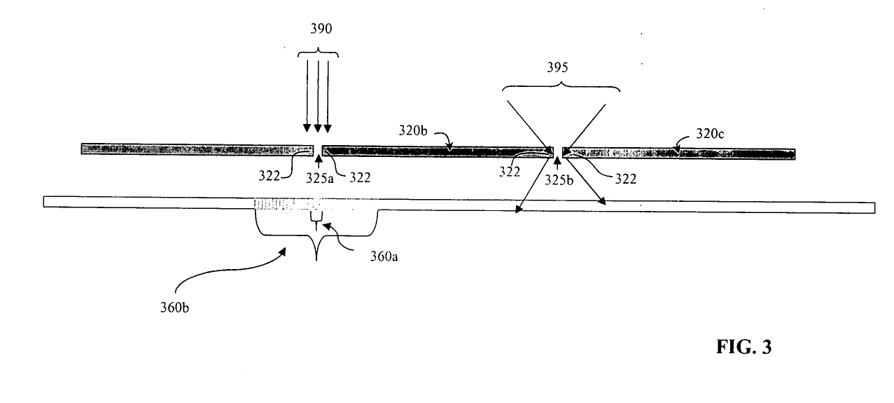

The gaps between adjacent correction elements generate unwanted optical effects such as gap ripples and shadows. An example of these effects is illustrated in FIG. 3. FIG. 3 depicts a portion of a correction system 330 having a plurality of adjacent correction elements 320a-c. Adjacent correction elements 320a-c are separated by gaps 325a,b. Because each gap has a 0% attenuation (or 100% transmission), light through the gaps generate streaks or bands of greater intensity on the substrate. The intensity of the streaks is dependent upon the angle of the incident light. For example, when the light beams are substantially parallel as shown by light 390 in FIG. 3 (i.e., the light has a small sigma), the maximum amount of light comes through the gap. When the light is spread through a variety of angles as shown by light 395 in FIG. 3 (i.e., light has a larger sigma), a portion of the light is reflected causing a decrease in the intensity of the streaks. As the angle increases (i.e., sigma increases), less light that gets through the gap further decreasing the intensity of the streaks. Area 360a is the area of greater intensity due to the gap when the incident light has the smallest sigma. Area 360b is the area of greater intensity due to the gap when the incident light has the largest sigma. As illustrated, area 360a is narrower than area 360b. However, light in area 360a has a greater intensity than light in area 360b.

As can be seen in FIG. 3, each correction element has a finite thickness. Thus, each correction elements has a plurality of edges 322. If light is coming in on an angle (i.e., larger sigma), part of the light reflects off the edge 322, casting a shadow on the substrate. When two correction elements 320b, c are adjacent and light is coming in on an angle from one side, a shadow is cast by the edge 322 of the first finger 320b and a second shadow is cast by the edge 322 of the second finger 320c. The shadow effect can be exacerbated by the illumination mode being used. For example, if dipole illumination is used, light is incident on the correction elements from a first direction and from a second direction opposite the first direction. Thus, the edges of adjacent fingers cause four shadows to be cast on the substrate in addition to the streak of greater intensity caused by the gap.

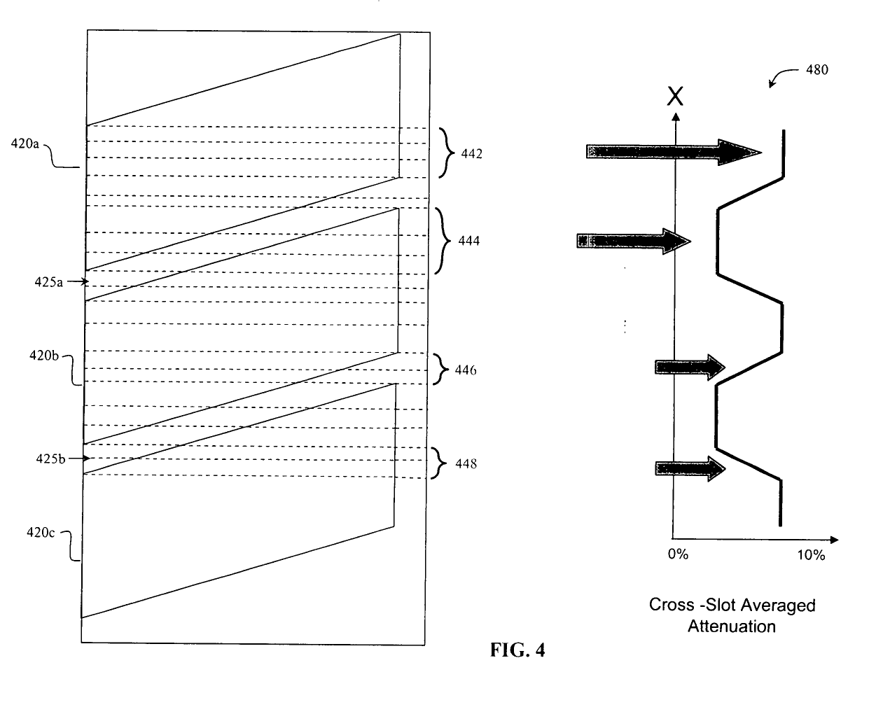

FIG. 4 further illustrates the cause of gap ripple. FIG. 4 depicts a portion 435 of an illumination slot having multiple adjacent correction elements 420a-c inserted from the left side. The adjacent correction elements 420a-c are separated by gaps 425a, b. FIG. 4 further depicts the cross-slot averaged attenuation 480 associated with the correction system.

As shown in FIG. 4, scan lines 442 do not enter or cross the gap region 425a. As a result, cross slot attenuation is normal (at approximately 8% attenuation). Scan lines 444 cross gap region 425a. As a result, more light comes through, increasing intensity and decreasing attenuation. Scan lines 446 enter gap region 425b but do not cross a gap region 425a or b. As a result, cross slot attenuation is variable. Scan lines 448 also enter gap region 425b but do not cross a gap region 425a or b. As a result, cross slot attenuation is variable. Thus, as can be seen in the plot of cross-slot averaged attenuation, an attenuation ripple is generated.

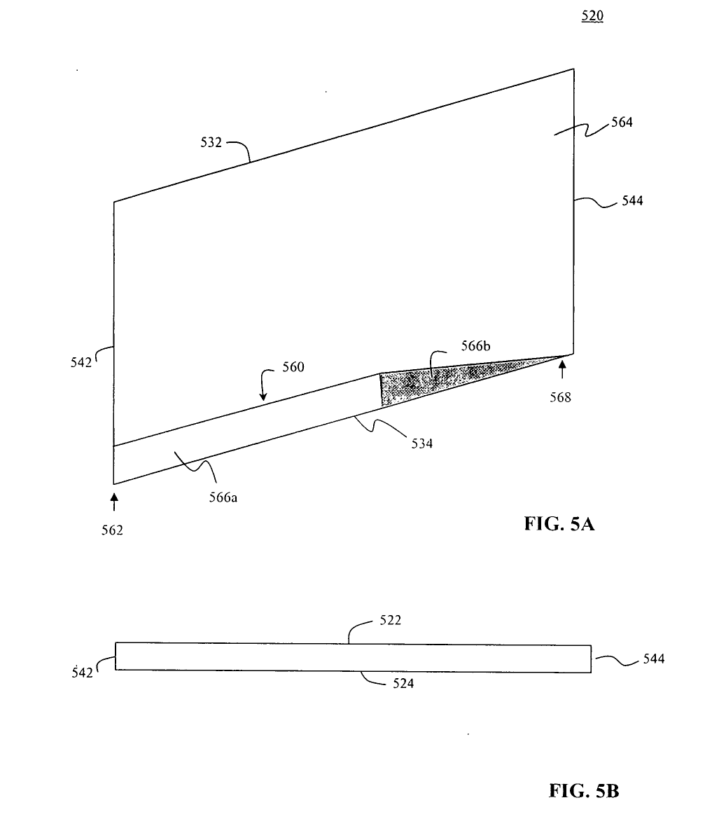

FIGS. 5A and B depict an exemplary correction element 520, having compensation for optical effects caused by edges and gaps between correction elements, according to an embodiment of the present invention. FIG. 5A is a top down view and FIG. 5B is a side view of correction element 520. Correction element 520 is defined by a first surface 522, a second surface 524, a first longitudinal edge 532, a second longitudinal edge 534, a first latitudinal edge 542, and a second latitudinal edge 544.

Correction element 520 further includes a compensation portion 560 (also referred to as a compensation band) and a normal attenuation portion 564. As depicted in FIG. 5, in an embodiment, compensation band 560 is located on first surface 522 and extends from a first point 562 on the second longitudinal edge 534 to a second point 564 on second longitudinal edge 534. In an embodiment, first point 562 is coincident with the first latitudinal edge 542 and second point 568 is coincident with second latitudinal edge 544. Thus, in this embodiment, compensation band 560 extends the length of the correction element. However, as would be appreciated by person of skill in the art, first point 562 and second point 568 could be located anywhere along the second longitudinal edge. Thus, in these embodiments, the length of the band is less than the length of the correction element.

Compensation portion 560 has a first attenuation and normal attenuation portion 564 has a second attenuation. In an embodiment, the attenuation of compensation portion 560 is greater than the attenuation of normal attenuation portion 564. For example, normal attenuation portion 564 can have an attenuation of 10% and the compensation portion 560 can have an attenuation of 20%. As would be appreciated by a person of skill in the art, different values for the attenuation of the normal attenuation portion and the compensation portion can be used as required for the lithography system. Furthermore, normal attenuation portion 564 may include multiple attenuation segments, each having an attenuation value or normal attenuation portion 564 may have a variable attenuation.

In an embodiment, compensation portion 560 has a uniform width. In an embodiment, the width of compensation portion 560 is equal to the width of the gap between adjacent correction elements in the uniformity correction system. As would be appreciated by person of skill in the art, compensation band 560 can have other widths as required by the lithography system.

In an alternate embodiment, compensation portion 560 includes multiple segments 566 a, b. In this embodiment, segment 566a has a uniform width and segment 566b has a variable width. Although compensation portion 560 is depicted as only having two segments, any number of segments having uniform or variable widths can be used. In an embodiment, the width of one or more segments is equal to the width of the gap between adjacent correction elements in the uniformity correction system. As would be appreciated by person of skill in the art, the segments 566 of compensation portion 560 can have other widths as required by the lithography system.

In an embodiment, compensation portion 560 has a quadrilateral shape. In alternate embodiments, compensation portion 560 can have any geometric shape including triangular or polygonal. Compensation portion 560 can also include segments having non-straight edges.

Compensation portion 560 can be formed of any material having a non-zero attenuation. For example, compensation portion 560 may be a coating comprised of a series of dots having a certain density. The attenuation of the coating can be modified by changing the density of the dots. Compensation portion 560 may also be a continuous coating or a material layer coupled to the surface of the correction element. Alternatively, compensation portion 560 may be etched into the surface of the correction element. In a further embodiment, compensation portion 560 could be a component of the correction element (e.g., correction element could be formed having compensation portion 560 integrated within its structure).

Correction element 520 can be used as correction elements in any configuration used by the uniformity correction system. For example, one or more correction elements 520 could be used as correction elements in the titled configuration of FIG. 2A or the chevron configuration of FIG. 2B.

Although FIG. 5 depicts compensation portion 560 as being located on first surface 522 and extending along the second longitudinal edge 534, persons of ordinary skill in the art will recognize that other configurations could be used. In an embodiment, compensation portion could be located on the first surface and extend from a first point on the first longitudinal edge to a second longitudinal edge. Alternatively, compensation portion could be located on the second surface and extend along the first or second longitudinal edges.

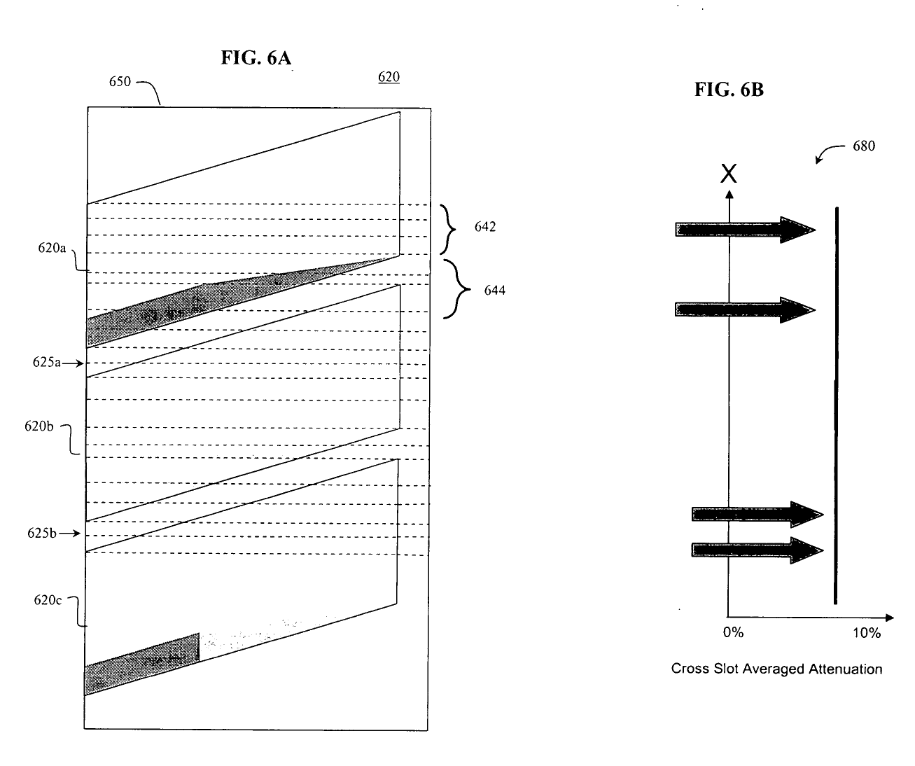

FIG. 6A depicts a portion of an exemplary uniformity correction system 620 having light leak compensation, according to an embodiment of the present invention. Correction system 620 includes a plurality of correction elements 520. As described above, each correction element 520 includes a compensation portion 560 and a normal attenuation portion 564.

In an embodiment, uniformity correction system 620 includes an optional optical compensation plate 650. The optical compensation plate 650 can be located above of the plurality of correction elements. Alternatively, the optical compensation plate 650 can be located below the plurality of corrections. In an embodiment, optical compensation plate 650 includes additional means for compensating for optical effects caused by the gap between the correction elements such as described in co-pending application, “Uniformity Correction System Having Light Leak and Shadow Compensation,” filed Dec. _{—}, 2004, Attorney Docket Number 1857.3340000, which is herein incorporated by reference in its entirety.

FIG. 6B depicts the cross-slot averaged attenuation 680 with the uniformity correction system 620 having light leak compensation. As shown in FIG. 6A, scan lines 642 do not enter the gap region 625a. Thus, cross slot attenuation is normal. Scan lines 644 cross equal lengths of gap and compensation region, resulting in normal cross-slot attenuation. As depicted in FIG. 6B, correction system 620 improves the light leak generated by the gaps between adjacent correction elements.

### 3. CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A uniformity correction system comprising:
a plurality of correction elements, each correction element including a compensation portion and a normal attenuation portion,
wherein the compensation portion has a first attenuation and the normal attenuation portion has a second attenuation.

2. The system of claim 1, wherein the first attenuation is greater than the second attenuation.

3. The system of claim 1, wherein the normal attenuation portion includes a plurality of normal attenuation segments, each having an attenuation.

4. The system of claim 1, wherein each correction element is separated from an adjacent correction element by a gap, and wherein the width of the compensation portion is equivalent to the width of the gap separating adjacent fingers.

5. A uniformity correction system comprising:
a plurality of correction elements, each correction element having a first surface and a second surface,
wherein each correction element has a compensation band on the first surface, and
wherein, for each correction element, the compensation band has a first attenuation and the correction element has a second attenuation.

6. The system of claim 5, wherein each compensation band has a first segment and a second segment, and wherein the first segment has a uniform width and the second segment has a variable width.

7. The system of claim 5, wherein each correction element is separated from an adjacent correction element by a gap, and wherein the width of the compensation band is equal to the width of the gap separating adjacent fingers.

8. The system of claim 6, wherein each correction element is separated from an adjacent correction element by a gap, and wherein the width of the first segment is equal to the width of the gap separating adjacent fingers.

9. The system of claim 5, wherein each correction element further has a first longitudinal edge, a second longitudinal edge, a first latitudinal edge, and a second latitudinal edge, and
wherein the compensation band extends from a first point on the second longitudinal edge to a second point on the second longitudinal edge.

10. The system of claim 5, wherein each correction element further has a first longitudinal edge, a second longitudinal edge, a first latitudinal edge, and a second latitudinal edge, and
wherein the compensation band extends from a first point on the first longitudinal edge to a second point on the first longitudinal edge.

11. The system of claim 9, wherein the first point is coincident with the first latitudinal edge.

12. The system of claim 9, wherein the second point is coincident with the second latitudinal edge.

13. The system of claim 10, wherein the first point is coincident with the first latitudinal edge.

14. The system of claim 10, wherein the second point is coincident with the second latitudinal edge.

15. The system of claim 5, wherein the compensation band has a quadrilateral shape.

16. The system of claim 5, wherein the attenuation of the compensation band is greater than the attenuation of the correction element.

17. A uniformity correction system comprising:
a plurality of correction elements, each correction element having a first surface and a second surface,
wherein each correction element has a compensation band on the second surface, and
wherein, for each correction element, the compensation band has a first attenuation and the correction element has a second attenuation.

18. The system of claim 17, wherein each correction element further has a first longitudinal edge, a second longitudinal edge, a first latitudinal edge, and a second latitudinal edge, and
wherein the compensation band extends from a first point on the second longitudinal edge to a second point on the second longitudinal edge.

19. The system of claim 17, wherein each correction element further has a first longitudinal edge, a second longitudinal edge, a first latitudinal edge, and a second latitudinal edge, and
wherein the compensation band extends from a first point on the first longitudinal edge to a second point on the first longitudinal edge.

20. The system of claim 17, wherein the attenuation of the compensation band is greater than the attenuation of the correction element.
